(19) United States
(12) Patent Application Publication
(10) Pub. No.: US 2025/0139451 A1
(43) Pub. Date: May 1, 2025

(54) MULTI-LEG NEURAL NETWORK HAVING TRANSFER LEARNING

(71) Applicant: International Business Machines Corporation, Armonk, NY (US)

(72) Inventors: Vadim Ratner, Haifa (IL); Yoel Shoshan, Haifa (IL)

(21) Appl. No.: 18/494,120

(22) Filed: Oct. 25, 2023

(51) Int. Cl. G06N 3/096; G06N 3/045

(52) U.S. Cl. CPC G06N 3/096; G06N 3/045

(57) ABSTRACT

Embodiments of the invention provide a computer-implemented method that includes executing a multi-leg neural network (NN) having a first-NN-leg and a second-NN-leg. The first-NN-leg includes first-NN-leg layers. A first layer of the first-NN-leg layers is at a first depth location in the first NN-leg that corresponds with a first depth location in the second-NN-leg. A second layer of the first-NN-leg layers is at a second depth location in the first-NN-leg that corresponds with a second depth location in the second-NN-leg. Information of the first layer of the first-NN-leg layers is sourced from the first depth location in the second-NN-leg. Information of the second layer of the first-NN-leg layers is sourced from the second depth location in the second-NN-leg.

### BACKGROUND

The present invention relates in general to programmable computers that are used to implement predictive neural networks as part of machine learning models and artificial intelligence.

### SUMMARY

Embodiments of the invention provide a computer-implemented method that includes executing a multi-leg neural network (NN) having a first-NN-leg and a second-NN-leg. The first-NN-leg includes first-NN-leg layers. A first layer of the first-NN-leg layers is at a first depth location in the first NN-leg that corresponds with a first depth location in the second-NN-leg. A second layer of the first-NN-leg layers is at a second depth location in the first-NN-leg that corresponds with a second depth location in the second-NN-leg. Information of the first layer of the first-NN-leg layers is sourced from the first depth location in the second-NN-leg. Information of the second layer of the first-NN-leg layers is sourced from the second depth location in the second-NN-leg.

Embodiments of the invention are also directed to computer systems and computer program products having substantially the same features and functionality as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2A depicts a simplified block diagram illustrating a model of a biological neuron operable to be utilized in neural network (NN) architectures in accordance with aspects of the invention;

FIG. 2B depicts a simplified block diagram illustrating a deep learning NN architecture in accordance with aspects of the invention;

FIG. 3 depicts a diagram illustrating a non-limiting example of a dimensionality reduction operation operable to utilize word embeddings in accordance with embodiments of the invention;

FIG. 4A depicts a simplified block diagram illustrating a non-limiting example of a transformer NN architecture operable to implement aspects of the invention;

FIG. 4B depicts a simplified block diagram illustrating a non-limiting example of an encoder element of a transformer NN architecture operable to implement aspects of the invention;

FIG. 4C depicts a simplified block diagram illustrating a non-limiting example of a decoder element of a transformer NN architecture operable to implement aspects of the invention;

FIG. 5 depicts a non-limiting example of a multi-leg NN system in accordance with aspects of the invention;

FIG. 6 depicts a non-limiting example of a multi-leg NN system derived from atomic models in accordance with aspects of the invention;

FIG. 7 depicts a non-limiting example of a multi-leg NN system in accordance with aspects of the invention;

FIG. 8A depicts a first part of a flow diagram illustrating a computer-implemented methodology according to aspects of the invention; and

FIG. 8B depicts a second part of the flow diagram depicted in FIG. 8A.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

Embodiments of the invention provide a computer-implemented method that includes executing a multi-leg neural network (NN) having a first-NN-leg and a second-NN-leg. The first-NN-leg includes first-NN-leg layers. A first layer of the first-NN-leg layers is at a first depth location in the first NN-leg that corresponds with a first depth location in the second-NN-leg. A second layer of the first-NN-leg layers is at a second depth location in the first-NN-leg that corresponds with a second depth location in the second-NN-leg. Information of the first layer of the first-NN-leg layers is sourced from the first depth location in the second-NN-leg. Information of the second layer of the first-NN-leg layers is sourced from the second depth location in the second-NN-leg.

The above-described embodiments of the invention provide technical benefits and technical effects. For example, the efficiency and effectiveness of the information exchange between NN legs are enhanced by performing the information exchange at multiple depth locations of the first-NN-leg and corresponding multiple depth locations of the second-NN-leg. The efficiency and effectiveness of the information exchange between NN legs are further enhanced by performing the information exchange for each layer of the first-NN-leg and the corresponding layer or layers of the second-NN-leg. Embodiments of the invention provide novel transfer learning techniques that leverage training data from a different but related domain to avoid the significant amount of time it takes to develop labeled training data for a given domain. The domain associated with the to-be-learned (TBL) task is referred to as the target domain (TD), and the domain of the different but related task is referred to as the source domain (SD). Accordingly, new and additional information of the second-NN-leg is incorporated within the prediction operations performed at each layer of the first-NN-leg, thereby further enhancing the efficiency and effectiveness of the prediction operations performed by the first-NN-leg. This implementation helps develop transfer learning operations that enable transfer learning processes that efficiently and effectively leverage SD training data to develop TD NN models, particularly where the target domain NN model is being designed to perform prediction and/or classification tasks based on a combination of individual data types (e.g., a patient's EHRs, medical images, genetic information, and the like) where training data configured as the combination of individual data types is insufficient to train a NN to an acceptable level of prediction/classification accuracy.

In addition to one or more of the features described above, or as an alternative to any of the foregoing embodiments of the invention, the executing includes receiving input that includes a first input type and a second input type to the multi-leg NN. In response to receiving the input, the multi-leg NN generates an output for a machine learning task.

With this embodiment, a structure is provided to develop transfer learning operations to develop TD NN models, particularly where the TD NN model is being designed to perform prediction and/or classification tasks based on a combination of individual data types (e.g., a patient's EHRs, medical images, genetic information, and the like) where training data configured as the combination of individual data types is insufficient to train a NN to an acceptable level of prediction/classification accuracy.

In addition to one or more of the features described above, or as an alternative to any of the foregoing embodiments of the invention, addition embodiments include the features that the second-NN-leg includes second-NN-leg layers. A first layer of the second-NN-leg layers is at the first depth location in the second-NN-leg. A second layer of the second-NN-leg layers is at the second depth location in the second-NN-leg. Information of the first layer of the second-NN-leg layers is sourced from the first depth location in the first-NN-leg. Information of the second layer of the second-NN-leg layers is sourced from the second depth location in the first-NN-leg.

The above-described embodiments of the invention provide technical benefits and technical effects. For example, the efficiency and effectiveness of the information exchange between NN legs are enhanced by performing the information exchange at multiple depth locations of the second-NN-leg and corresponding multiple depth locations of the first-NN-leg. The efficiency and effectiveness of the information exchange between NN legs are further enhanced by performing the information exchange for each layer of the second-NN-leg and the corresponding layer or layers of the first-NN-leg. Accordingly, new and additional information of the first-NN-leg is incorporated within the prediction operations performed at each layer of the second-NN-leg, thereby further enhancing the efficiency and effectiveness of the prediction operations performed by the second-NN-leg.

In addition to one or more of the features described above, or as an alternative to any of the foregoing embodiments of the invention, the first layer and the second layer are embedding layers, respectively.

The above-described embodiments of the invention provide technical benefits and technical effects. For example, the efficiency and effectiveness of the information exchange between NN legs are further enhanced by performing the information exchange for embedding layers of the first-NN-leg and the corresponding embedding layer or layers of the second-NN-leg. Additionally, the efficiency and effectiveness of the information exchange between NN legs are further enhanced by performing the information exchange for embedding layers of the second-NN-leg and the corresponding embedding layer or layers of the first-NN-leg. By performing information exchanges through embedding layers, globalized features of the NN layers can be efficiently and effectively captured and transferred between the NN-legs of the multi-leg NN.

In addition to one or more of the features described above, or as an alternative to any of the foregoing embodiments of the invention, the first-NN-leg is operable to, responsive to a first type of input, perform a first task that generates a first instance of a type of predictive output. The second-NN-leg is operable to, responsive to a second type of input, perform a second task that generate a second instance of the type of predictive output.

The above-described embodiments of the invention provide technical benefits and technical effects. For example, the efficiency and effectiveness of the information exchange between NN legs are enhanced because the multi-depth, multi-layer information exchange allows the first-NN-leg to improve its performance of the first task by incorporating, through the multi-depth multi-layer information exchange, information learned by the second-NN-leg while performing the second task. Similarly, the efficiency and effectiveness of the information exchange between NN legs are enhanced because the multi-depth, multi-layer information exchange allows the second-NN-leg to improve its performance of the second task by incorporating, through the multi-depth multi-layer information exchange, information learned by the first-NN-leg while performing the first task. In this manner, the multi-leg-NN in accordance with aspects of the invention is operable to effectively and efficiently perform prediction or classification tasks based on a combination of individual data types (e.g., a patient's EHRs, medical images, genetic information, and the like) where training data configured as the combination of individual data types (e.g., the first type of input and the second type of input) is insufficient to train a NN to an acceptable level of prediction/classification accuracy.

In addition to one or more of the features described above, or as an alternative to any of the foregoing embodiments of the invention, at least a portion of the first type of input is different from at least a portion of the second type of input. At least a portion of the first task is different from at least a portion of the second task. The multi-leg NN generates a final instance of the type of predictive output based at least in part on the first instance of the type of predictive output and on the second instance of the type of predictive output.

The above-described embodiments of the invention provide technical benefits and technical effects. For example, the previously-described features of the multi-leg NN operate on scenarios where the first type of input has differences and overlap with the second type of input. Additionally, the improved predictive outputs generated by the first-NN-leg and the second-NN-leg combine to generate an improved final instance of the predictive output.

In addition to one or more of the features described above, or as an alternative to any of the foregoing embodiments of the invention, the multi-leg NN further includes a third-NN-leg that, responsive to a third type of input, performs a third task that generates a third instance of the type of predictive output.

With this embodiment, additional input is usable to help refine a final output for a machine learning task.

In addition to one or more of the features described above, or as an alternative to any of the foregoing embodiments of the invention, information of the third-NN-leg is sourced from the second-NN-leg. The multi-leg NN generates a final instance of the type of predictive output based at least in part on the first instance of the type of predictive output; the second instance of the type of predictive output; and the third instance of the type of predictive output.

The above-described embodiments of the invention provide technical benefits and technical effects. For example, the previously-described features of the multi-leg NN can incorporate additional NN-legs, including, for example, the third-NN-leg. Additionally, the third-NN-leg can be configured and arranged to bring a third type of input into the multiple instances of the predictive outputs generated by the multi-leg NN system. The efficiency and effectiveness of the information exchange between NN legs are further enhanced by performing the information exchange at multiple depth locations of the third-NN-leg and corresponding multiple depth locations of the second-NN-leg. The efficiency and effectiveness of the information exchange between NN legs are further enhanced by performing the information exchange for each layer of the third-NN-leg and the corresponding layer or layers of the second-NN-leg. Accordingly, new and additional information of the second-NN-leg is incorporated within the prediction operations performed at each layer of the third-NN-leg, thereby further enhancing the efficiency and effectiveness of the prediction operations performed by the third-NN-leg.

In addition to one or more of the features described above, or as an alternative to any of the foregoing embodiments of the invention, the third-NN-leg is insufficient to perform the third task without the information that is sourced from the second-NN-leg.

With this embodiment, a technical synergy is achieved whereby predictive benefit from an input of a new type is achieved that alone would be insufficient to perform the predictive task.

Embodiments of the invention are also directed to computer systems and computer program products having substantially the same features and functionality as the computer-implemented methods described above.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The components/modules of the systems illustrated herein are depicted separately for ease of illustration and explanation. In embodiments of the invention, the functions performed by the components/modules can be distributed differently than shown without departing from the scope of the various embodiments of the invention describe herein unless it is specifically stated otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

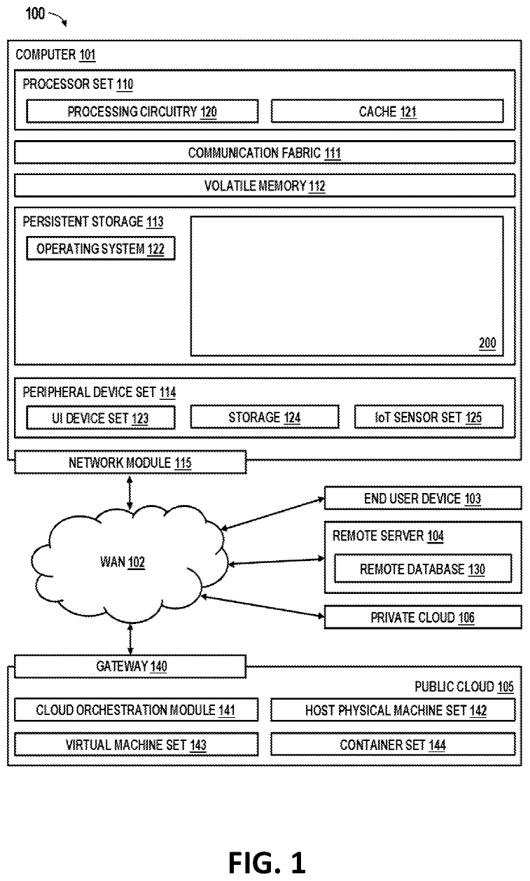

FIG. 1 depicts a computing environment 100 that contains an example of an environment for the execution of at least some of the computer code involved in performing the inventive methods, such as code block 200 operable to implement multi-depth, multi-layer transfer learning information exchange. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

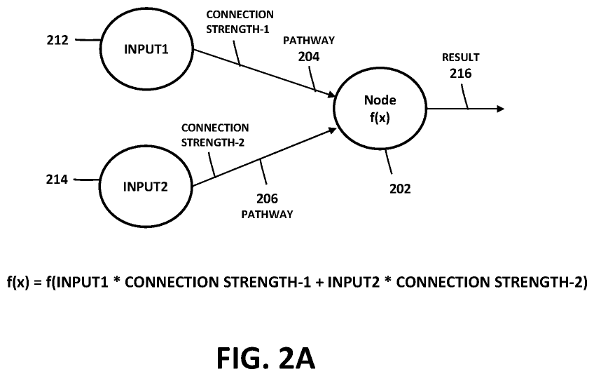

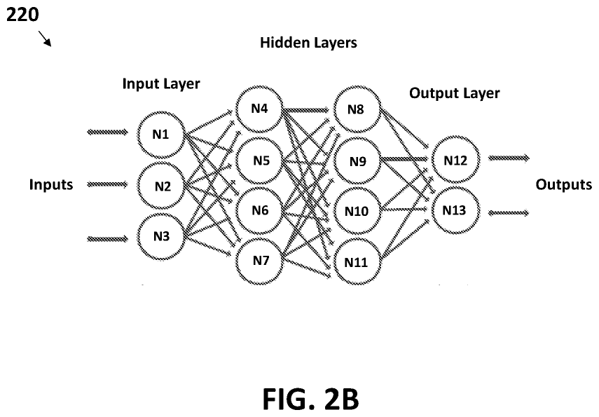

Embodiments of the invention can be implemented using NNs, which are a specific category of machines that can mimic human cognitive skills. In general, a NN is a network of artificial neurons or nodes inspired by the biological neural networks of the human brain. In FIG. 2A, the biological neuron is modeled as a node 202 having a mathematical function, f(x), depicted by the equation shown in FIG. 2A. Node 202 receives electrical signals from inputs 212, 214, multiplies each input 212, 214 by the strength of its respective connection pathway 204, 206, takes a sum of the inputs, passes the sum through a function, f(x), and generates a result 216, which may be a final output or an input to another node, or both. In the present specification, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 2B depicts a simplified example of a deep learning NN architecture (or model) 220. In general, NNs can be implemented as a set of algorithms running on a programmable computer (e.g., computer 101 and/or remote server 104 of the computing environment 100 shown in FIG. 1). In some instances, NNs are implemented on an electronic neuromorphic machine (e.g., the IBM®/DARPA SYNAPSE computer chip) that attempts to create connections between processing elements that are substantially the functional equivalent of the synapse connections between brain neurons. In either implementation, NNs incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a NN is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The NN is “trained” by performing multiple iterations of learning-based analysis on the real-world data vectors until patterns (or relationships) contained in the real-world data vectors are uncovered and learned.

NNs use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a NN can be used to perform a variety of tasks, two of the more common tasks are labeling (or classification) of real-world data and determining the similarity between segments of real-world data. Classification tasks often depend on the use of labeled datasets to train the NN to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Similarity tasks apply similarity techniques and (optionally) confidence levels (CLs) to determine a numerical representation of the similarity between a pair of items.

Returning again to FIG. 2B, the simplified NN architecture/model 220 is organized as a weighted directed graph, where the artificial neurons are nodes (e.g., N1-N13), and where weighted directed edges (i.e., directional arrows) connect the nodes. The NN architecture/model 220 is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. Having multiple hidden layers indicates that the NN architecture/model 220 is a deep learning NN architecture/model. Each node is connected to every node in the adjacent layer by connection pathways, which are depicted in FIG. 2B as directional arrows each having its own connection strength. For ease of illustration and explanation, one input layer, two hidden layers, and one output layer are shown in FIG. 2B. However, in practice, multiple input layers, multiple hidden layers, and multiple output layers can be provided. When multiple hidden layers are provided, the NN model 220 can perform unsupervised deep-learning for executing classification/similarity type tasks.

Similar to the functionality of a human brain, each input layer node N1, N2, N3 of the NN 220 receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathway into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The NN model 220 can be implemented as a feedforward NN or a recurrent NN. A feedforward NN is characterized by the direction of the flow of information between its layers. In a feedforward NN, information flow is unidirectional, which means the information in the model flows in only one direction—forward—from the input nodes, through the hidden nodes (if any) and to the output nodes, without any cycles or loops. In contrast to recurrent NNs, which have a bi-directional information flow, feedforward NNs are trained using the backpropagation method.

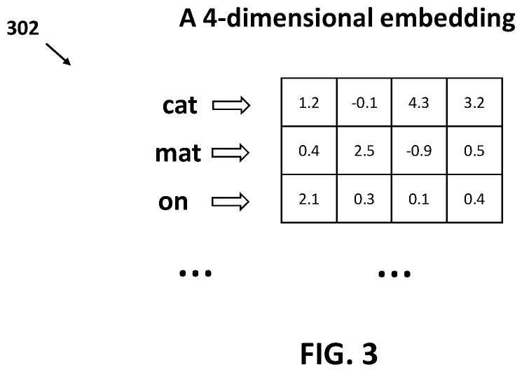

Some embodiments of the invention utilize and leverage embedding spaces. An embedding is a relatively low-dimensional space into which high-dimensional vectors can be translated. Embeddings make it easier to apply machine learning to large inputs like sparse vectors representing words. FIG. 3 illustrates the concept of embedding using an example word embedding 302. In general, NN models take vectors (i.e., an array of numbers) as inputs. Where the inputs are natural language symbols, token/word vectorization refers to techniques that extract information from the natural language symbol corpus and associate to each word of the natural language symbol corpus a vector using a suitable vectorization algorithm that takes into account the word's context.

Embeddings are a way to use an efficient, dense vector-based representation in which similar words have a similar encoding. In general, an embedding is a dense vector of floating-point values. In a word embedding, words are represented by dense vectors where a vector represents the projection of the word into a continuous vector space. The length of the vector is a parameter that must be specified. However, the values of the embeddings are trainable parameters (i.e., weights learned by the model during training in the same way a model learns weights for a dense layer). More specifically, the position of a word within the vector space of an embedding is learned from text in the relevant language domain and is based on the words that surround the word when it is used. The position of a word in the learned vector space of the word embedding is referred to as its embedding.

FIG. 3 depicts an example diagram of a word embedding 302 in an English language domain. As shown in FIG. 3, each word is represented as a 4-dimensional vector of floating-point values. Another way to think of the word embedding 302 is as a “lookup table.” After the weights have been learned, each word can be encoded by looking up the dense vector it corresponds to in the table. The embedding layer (or lookup table) maps from integer indices (which stand for specific words) to dense vectors (their embeddings). The dimensionality (or width) of the embedding is a parameter that can be selected to match the task for which it is designed. When an embedding layer is created, the weights for the embeddings are randomly initialized (just like any other layer). During training, the weights are gradually adjusted via back-propagation training techniques. Once trained, the learned word embeddings will roughly encode similarities between words (as they were learned for the specific problem on which the model is trained). The general techniques used in word embedding apply to embeddings in other domains, including domains used in embodiments of the invention.

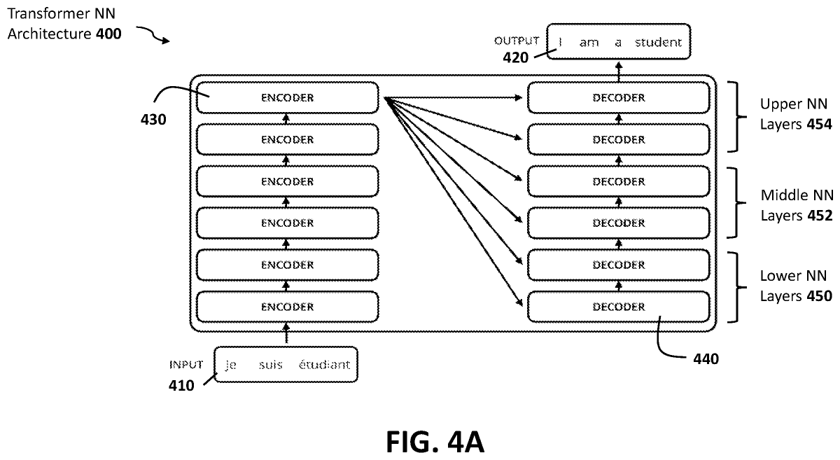

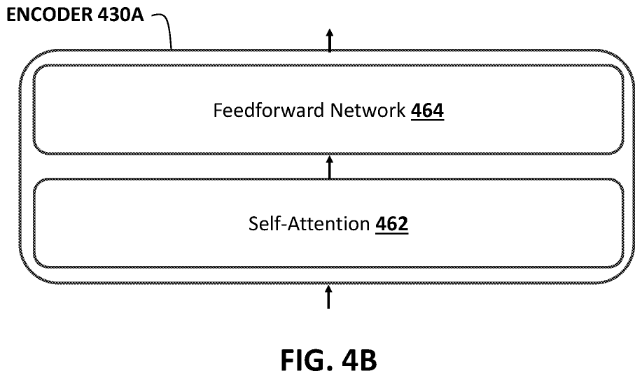

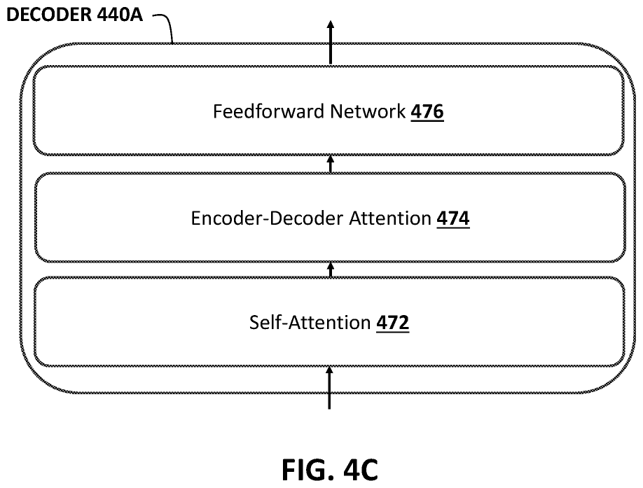

FIGS. 4A, 4B and 4C depict a non-limiting example of various aspects of a transformer NN architecture 400 that can be utilized to implement some aspects of the invention. More specifically, FIG. 4A depicts a simplified block diagram illustrating a non-limiting example of the transformer NN architecture 400; FIG. 4B depicts a simplified block diagram illustrating a non-limiting example of an encoder 430A of the transformer NN architecture 400; and FIG. 4C depicts a simplified block diagram illustrating a non-limiting example of a decoder 440A of the transformer NN architecture 400.

The transformer NN architecture 400 includes tokenization and embedding features. In embodiments of the invention, the transformer NN architecture 400 converts text and other data to vectors and back using tokenization, positional encoding, and embedding layers. The transformer NN architecture 400 is a sequence-to-sequence NN architecture in which input text is encoded with tokenizers to sequences of integers called input tokens. Input tokens are mapped to sequences of vectors (e.g., word embeddings) via embeddings layers. Output vectors (embeddings) can be classified to a sequence of tokens, and output tokens can then be decoded back to text.

More generally, tokenization is cutting input data into parts (symbols) that can be mapped (embedded) into a vector space. For example, input text is split into frequent words, which is an example of transformer tokenization. In some instances, special tokens can be appended to the sequence (e.g., class tokens) used for classification embeddings. Positional encodings add token order information. Self-attention and feed-forward layers are symmetrical with respect to the input so positional information is provided about each input token so positional encodings or embeddings are added to token embeddings in transformer encodings. Accordingly, embeddings are learned and/or trained.

As shown in FIG. 4A, the transformer NN architecture 400 includes a series or sequence of encoders 430 and a sequence of decoders 440 configured and arranged as shown. The encoders 430 and decoders 440 are organized around groups of layers including lower NN layers 450, middle NN layers 452, and upper NN layers 454. The transformer NN architecture 400 receives an input 410 (e.g., a sentence in French), uses the encoders 430 and the decoders 440 to perform a task (e.g., translating a French sentence to an English sentence), and, responsive to the input 410 generates an output 420 (e.g., an English translation of a French sentence). More specifically, the encoders 430 are configured and arranged to take the input 410, for example a sentence (i.e., sequences) written in French, and mapping it to high-dimensional representation(s). The encoders 430 are configured to “learn” the parts of the input 410 (i.e., the sequence) that are important and pass them to the high-dimensional representation, and the less-important aspects of the input 410 (e.g., the sequence) are left out. At this stage, the high-dimensional representation cannot be easily understood because there are no semantics involved and the complete mapping has not yet been learned.

The decoders 440 are configured to convert the high-dimensional representation into the output 420, which, in this example, is a sequence (e.g., a sequence written in English). Utilizing the encoders 430 and the decoders 440 allows models to be built that can transduce (i.e., map without losing semantics) “one way” into “another,” e.g., French into English. By training the encoders 430 and the decoders 440 together, a sequence-to-sequence model is created. A sequence-to-sequence model is capable of ingesting a sequence of a particular kind and outputting another sequence of another kind.

In embodiments of the invention, the transformer NN architecture 400 (also known as a generative language model) can be trained to perform the various tasks described herein. In the transformer NN architecture 400, the encoders 430 can be organized in layers (e.g., lower NN layers 450, middle NN layers 452, and upper NN layers 454) that process the input 410 iteratively one layer after another; and the decoders 440 can also be organized in corresponding layers (e.g., lower NN layers 450, middle NN layers 452, and upper NN layers 454) that do the same thing to the output of the last encoder 430. The function of each encoder 430 in a given layer is to process its input to generate encodings that contain information about which parts of the inputs are relevant to each other. The encoder 430 in one layer passes its set of encodings to the encoder 430 in the next layer as inputs. Each decoder 440 in a corresponding layer does the opposite, taking the output from the last encoder 430 and processing them, using their incorporated contextual information, to generate the output 420. To achieve this, each encoder 430 of a given layer makes use of an attention mechanism (e.g., self-attention 462 shown in FIG. 4B). In the context of NNs, an attention mechanism is a technique that electronically mimics human cognitive attention. The effect enhances the important parts of the input data and fades out the rest such that the NN devotes more computing power on that small but important part of the data. The part of the data that is more important than other parts of the data depends on the context and is learned through training data by gradient descent. Thus, the attention mechanism of the transformer NN architecture 400 weighs the relevance of every other input and draws information from them accordingly to produce the output. Each decoder 440 can include an additional attention mechanism (e.g., self-attention 472 and encoder-decoder attention 474 shown in FIG. 4C) that draws information from the outputs of previous decoders 440 before the current decoder 440 draws information from the encodings. The encoders 430 and the decoders 440 each include a feedforward network (e.g., feedforward network 464 shown in FIG. 4B, and feedforward network 476 shown in FIG. 4C) for additional processing of the outputs, and also contain residual connections and layer normalization steps.

FIG. 4B depicts a simplified block diagram illustrating a non-limiting example of how the encoder 430 (shown in FIG. 4A) can be implemented as the encoder 430A; and FIG. 4C depicts a simplified block diagram illustrating a non-limiting example of how the decoder 440 (shown in FIG. 4A) can be implemented as the decoder 440A. The encoders 430 are very similar to each other, and the decoders 440 are very similar to each other, as well. As shown in FIG. 4B, each encoder 430A includes two sub-layers, namely, a self-attention 462 and a feedforward network 464. The inputs to the encoder 430A first flow through the self-attention 462, which helps the encoder 430A look at other parts of the input 410 as it encodes a specific word. The decoder 440A shown in FIG. 4C has a corresponding self-attention 472 and feedforward network 476 that perform substantially the same functions in the decoder 440A as the self-attention 462 and the feedforward network 464 perform in the encoder 430A. The decoder 440A further includes encoder-decoder attention 474 that helps the decoder 440A focus on relevant parts of the input sentence.

A specific category of machines that can mimic human cognitive skills is NNs. In general, a NN is a network of artificial neurons or nodes inspired by the biological neural networks of the human brain. The artificial neurons/nodes of a NN are organized in layers and typically include input layers, hidden layers and output layers. Machine learning differ from deep learning in that deep learning has more hidden layers than machine learning. Neuromorphic and synaptronic systems, which are also referred to as artificial neural networks (ANNs), are computational systems that permit electronic systems to essentially function in a manner analogous to that of biological brains. Neuromorphic and synaptronic systems do not generally utilize the traditional digital model of manipulating zeros (0s) and ones (1s). Instead, neuromorphic and synaptronic systems create connections between processing elements that are roughly functionally equivalent to neurons of a biological brain. Neuromorphic and synaptronic systems can be implemented using various electronic circuits that are modeled on biological neurons.

Data science combines math and statistics, specialized programming, advanced analytics, artificial intelligence (AI), and machine learning (ML) with specific subject matter expertise to uncover actionable insights hidden in an organization's data. These insights can be used to guide decision making and strategic planning. For example, a NN can be trained to solve a given problem on a given set of inputs. NN training is the process of teaching a NN to perform a task. NNs learn by initially processing several large sets of labeled or unlabeled data. By using these examples, NNS can “learn” to process unknown inputs more accurately. In a conventional scenario, the ability to create NNs to solve problems is limited by the availability of suitable training data sets. For example, NNs can be trained to assist with performing patient diagnosis, and the scope and variety of NNs used to perform diagnosis-assistance tasks is limited by the availability of suitable training data that can be used to train the NN on the given diagnosis-assistance task. Thus, if sufficient electronic health record (EHR) training data is available, a NN can be trained to classify a patient as sick or healthy based on that patient's EHR data. Similarly, if sufficient medical image (e.g., X-rays) training data is available, a NN can be trained to classify a patient as sick or health based on that patient's medical image information. Similarly, if sufficient genetic information training data is available, a NN can be trained to classify a patient as sick or healthy based on that patient's genetic information. Where several NNs are each making the same type of prediction but each NN uses a different data type, the predictions generated by each NN can be concatenated to generate a single combine prediction.

Ideally, rather than training multiple individual NNs to each make a separate NN prediction (e.g., a patient is sick or healthy) based on an individual data type (e.g., EHRs, medical images, genetic information, and the like) then concatenating the separate NN predictions to provide a single combined prediction, a single NN would be trained to make the single prediction (e.g., a patient is sick or healthy) based on a combination of the individual data types (e.g., the patient's EHRs, medical images, genetic information, and the like). In this manner, such a NN would more closely mimic the diagnosis procedure followed by a subject matter expert (SME) (e.g., a physician) by making a final diagnosis or prediction based on information from a variety of sources. However, the ability to create such a NN is limited because the readily available training data does not include combinations of a variety of types of data (e.g., the patient's EHRs, medical images, genetic information, and the like). Typical data sets include individual data types, for example a data set of EHRs, a data set of medical images, a data set of genetic information, and the like. However, it is atypical to find training data sets that include a combination of these data types organized for separate patients—for example a combined training data set that presents, for Patent A, Patent A's EHRs, Patient A's medical images, Patient A's genetic information, and the like. To the extent that such combined training data can be located, the quantity of such combined training data is sparse and insufficient to adequately train a NN.

It is a challenge to configure transfer learning operations that identify and transfer the deep features of the TD in a manner that enables the SD training data to train the TD NN model in an efficient and effective manner. Accordingly, there is a need to develop transfer learning operations that enable transfer learning processes that efficiently and effectively leverage SD training data to develop TD NN models, particularly where the TD NN model is being designed to perform prediction or classification tasks on the previously-described combined data sets.

Transfer learning is a machine learning method where a machine learning model developed for a first task is reused as the starting point for a model on a second, different but related task. For example, in a deep learning application, pre-trained models are used as the starting point on a variety of computer vision and natural language processing tasks. Transfer learning leverages through reuse the vast knowledge, skills, computer, and time resources required to develop neural network models. Transfer learning techniques have been developed that leverage training data from a different but related domain in an attempt to avoid the significant amount of time it takes to develop labeled training data for a given domain. The domain associated with the to-be-learned (TBL) task is referred to as the target domain (TD), and the domain of the different but related task is referred to as the source domain (SD).

The present embodiments refer to information sourcing from one leg of a multi-leg neural network to another multi-leg neural network and occurs via cross-attention stitches. The cross-attention stitches can, in some embodiments of the invention, occur between embedding layers of one leg and another leg. The cross-attention stitches occur pairwise amongst particular leg pairs and/or across all legs of the multi-leg neural network. A smooth transition for the multi-leg neural network starts with straightforward combination of outputs. Via training, the multi-leg neural network gradually learns to propagate information between the individual legs. Fine-tuning of network weights occurs in at least some embodiments of the invention. The cross-attention stitches are able to be implemented in a variety of machine learning models including models with convolutional neural network (CNN)-based backbones. The cross-attention stitches occur in information exchanges at multiple depths with multiple cross-attention layers respectively. The system has relatively few weights to learn because it is generally applied on embedding layers and not in localized feature spaces.

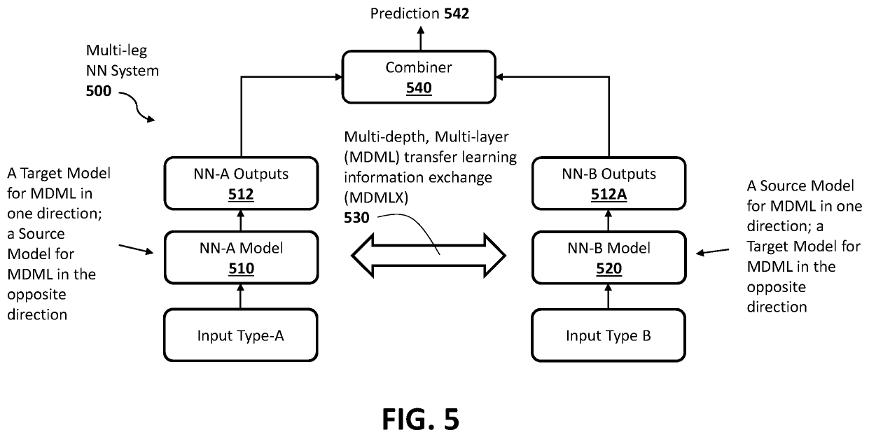

FIG. 5 depicts a simplified block diagram illustrating a non-limiting example of a multi-leg NN system 500 in accordance with aspects of the invention. As shown, the multi-leg NN system 500 includes first-NN-leg implemented as a NN-A model 510, along with a second-NN-leg implemented as a NN-B model 520, configured and arranged as shown. In some embodiments of the invention, the NN-A model 510 and the NN-B model 520 can each be implemented using substantially the same architecture and functionality as the transformer NN architecture 400 (shown in FIG. 4A). In some embodiments of the invention, NN-A model 510 can be trained to solve a given problem on input Type-A. The training applied to the NN-A model 510 teaches the NN-A model 510 to perform a task that solves the given problem on input Type-A. The NN-A model 510 learns by initially processing several sets of labeled or unlabeled data, which are examples of input Type-A. By using these examples, the NN-A model 510 can “learn” to process unknown inputs (e.g., unknown inputs of Type-A) more accurately. The NN-A model 510 generates NN-A outputs 512 which represent one instance of a solution to the given problem based on an analysis of input Type-A. Similarly, the NN-B model 520 can be trained to solve the same given problem on input Type-B. The training applied to the NN-B model 520 teaches the NN-B model 520 to perform a task that solves the given problem on input Type-B. The NN-B model 520 learns by initially processing several sets of labeled or unlabeled data, which are examples of input Type-B. By using these examples, the NN-B model 520 can “learn” to process unknown inputs (e.g., unknown inputs of Type-B) more accurately. The NN-B model 520 generates NN-B outputs 512A, which represent another instance of a solution to the given problem based on an analysis of input Type-B.

As an example, the above-described given problem can be determining whether or not Patient-A has disease-A; input Type-A can be Patient A's EMRs; the task performed by NN-A model 510 can be analyzing input Type-A to generate one instance of a prediction of whether or not Patient-A has disease-A; and the NN-A output 512 can be the one instance of the prediction of whether or not Patient-A has disease-A. Similarly, input Type-B can be Patient A's medical images (e.g., X-rays); the task performed by NN-B model 520 can be analyzing input Type-B to generate another instance of the prediction of whether or not Patient-A has disease-A; and the NN-B output 512A can be the other instance of the prediction of whether or not Patient-A has disease-A. A combiner 540 can use NN-A output 512 and NN-B output 512A to generate a single prediction 542 based on the predictions generated by the NN-A model 510 and the NN-B model 520. The combiner 540 can be implemented in any suitable manner such as a trained classifier, a voting system, and the like.

Ideally, a single NN would be trained to make the single prediction (e.g., Patient-A is sick or healthy) based on a combination of the individual data types (e.g., the patient's EHRs, medical images, genetic information, and the like). In this manner, such a NN would more closely mimic the diagnosis procedure followed by a subject matter expert (SME) (e.g., a physician) by making a final diagnosis or prediction based on information from a variety of sources. However, the ability to create such a NN is limited because the readily available training data does not include combinations of a variety of types of data (e.g., the patient's EHRs, medical images, genetic information, and the like). Typical data sets include individual data types, for example a data set of EHRs, a data set of medical images, a data set of genetic information, and the like. However, it is atypical to find training data sets that include a combination of these data types organized for separate patients—for example a combined training data set that presents, for Patent A, Patent A's EHRs, Patient A's medical images, Patient A's genetic information, and the like. To the extent that such combined training data can be located, the quantity of such combined training data is sparse and insufficient to adequately train a NN.

Embodiments of the invention address the above-described scarcity of training data in the form of combinations of different data types by configuring the multi-leg NN system 500 shown in FIG. 5 to include a multi-depth, multi-layer (MDML) transfer learning information exchange 530, which is referred to herein as MDMLX 530. In aspects of the invention, the MDMLX 530 can be an algorithm, and the entire multi-leg NN system 500 (including the NN-A model 510 and the NN-B model 520) can be implemented using the computing environment 100. In embodiments of the invention, the NN-A model 510 is configured to include a plurality of NN-A layers; and the NN-B model 520 is configured to include a plurality of NN-B layers. Each NN-A layer in the plurality of NN-A layers has an associated depth location in the NN-A model 510. The MDMLX 530 controls information flow between the NN-A model 510 and the NN-B model 520 such that information of each NN-A layer in the plurality of NN-A layers is sourced from one or more NN-B layers in the plurality of NN-B leg layers. The one or more NN-B layers have a depth location in the NN-B model 520 that corresponds to the associated depth location in the NN-A Model 510. Under this scenario, the NN-A model 510 is the target model for information flowing from the NN-B model 520 to the NN-A model 510.

Similarly, each NN-B layer in the plurality of NN-B layers has an associated depth location in the NN-B model 520. The MDMLX 530 controls information flow between the NN-B model 520 and the NN-A model 510 such that information of each NN-B layer in the plurality of NN-B layers is sourced from one or more NN-A layers in the plurality of NN-A layers. The one or more NN-A layers have a depth location in the NN-A model 510 that corresponds to the associated depth location in the NN-B model 520. Under this scenario, the NN-B model 520 is the target model for information flowing from the NN-A model 510 to the NN-B model 520.

Inventors of embodiments of the invention have discovered that the efficiency and effectiveness of the tasks performed by the NN-A model 510 are enhanced by increasing individual instances where information is exchanged from between corresponding depth locations of the NN-A model 510 and the NN-B model 520. In some embodiments of the invention, the efficiency and effectiveness of the tasks performed by the NN-A model 510 are enhanced by using the MDMLX 530 to perform an information exchange at multiple depth locations of the NN-A model 510 and corresponding multiple depth locations of the NN-B model 520. In some embodiments of the invention, the efficiency and effectiveness of the tasks performed by the NN-A model 510 are enhanced by using the MDMLX 530 to perform an information exchange at more than two (2) depth locations of the NN-A model 510 and corresponding more than two (2) depth locations of the NN-B model 520. In some embodiments of the invention, the efficiency and effectiveness of the tasks performed by the NN-A model 510 are enhanced by using the MDMLX 530 to perform an information exchange at about one half of the depth locations of the NN-A model 510 and corresponding about one-half of the depth locations of the NN-B model 520. In some embodiments of the invention, the efficiency and effectiveness of the tasks performed by the NN-A model 510 are enhanced by using the MDMLX 530 to perform an information exchange at more than about one half of the depth locations of the NN-A model 510 and corresponding more than about one-half of the depth locations of the NN-B model 520. In some embodiments of the invention, the efficiency and effectiveness of the tasks performed by the NN-A model 510 are further enhanced by using the MDMLX 530 to perform the information exchange for each layer of the NN-A model 510 and the corresponding layer or layers of the NN-B model 520. Accordingly, new and additional information of the NN-B model 520 is incorporated within the prediction operations performed at each layer of the NN-A model 510, thereby further enhancing the efficiency and effectiveness of the prediction operations performed by the NN-A model 510.

Similarly, in some embodiments of the invention, the efficiency and effectiveness of the tasks performed by the NN-B model 520 are enhanced by using the MDMLX 530 to perform an information exchange at multiple depth locations of the NN-B model 520 and corresponding multiple depth locations of the NN-A model 510. In some embodiments of the invention, the efficiency and effectiveness of the tasks performed by the NN-B model 520 are enhanced by using the MDMLX 530 to perform an information exchange at more than two (2) depth locations of the NN-B model 520 and corresponding more than two (2) depth locations of the NN-A model 510. In some embodiments of the invention, the efficiency and effectiveness of the tasks performed by the NN-B model 520 are enhanced by using the MDMLX 530 to perform an information exchange at about one half of the depth locations of the NN-B model 520 and corresponding about one-half of the depth locations of the NN-A model 510. In some embodiments of the invention, the efficiency and effectiveness of the tasks performed by the NN-B model 520 are enhanced by using the MDMLX 530 to perform an information exchange at more than about one half of the depth locations of the NN-B model 520 and corresponding more than about one-half of the depth locations of the NN-A model 510. In some embodiments of the invention, the efficiency and effectiveness of the tasks performed by the NN-B model 520 are further enhanced by using the MDMLX 530 to perform the information exchange for each layer of the NN-B model 520 and the corresponding layer or layers of the NN-A model 510. Accordingly, new and additional information of the NN-A model 510 is incorporated within the prediction operations performed at each layer of the NN-B model 520, thereby further enhancing the efficiency and effectiveness of the prediction operations performed by the NN-B model 520.

In some embodiments of the invention, the plurality of NN-A layers includes a plurality of NN-A embedding layers; and the plurality of NN-B layers includes a plurality of NN-B embedding layers. The efficiency and effectiveness of the information exchange between the NN-A model 510 and the NN-B model 520 are further enhanced by using the MDMLX 530 to perform the information exchange for embedding layers of the NN-A model 510 and the corresponding embedding layer or layers of the NN-B model 520. Additionally, the efficiency and effectiveness of the information exchange between the NN-A model 510 and the NN-B model 520 are further enhanced by using the MDMLX 530 to perform the information exchange for embedding layers of the NN-B model 520 and the corresponding embedding layer or layers of the NN-A model 510. By performing information exchanges through embedding layers, the MDMLX 530 can efficiently and effectively capture and transfer globalized features of the embedding layers of the NN-A model 510 and the embedding layers of the NN-B model 520 between the NN-A model 510 and the embedding layers of the NN-B model 520. In some instances, embedding layers are referred to as bottlenecks in a particular leg.

The efficiency and effectiveness of the information exchange between the NN-A model 510 and the NN-B model 520 are enhanced because the MDMLX 530 allows the NN-A model 510 to improve its performance of the NN-A task by incorporating, through the MDMLX 530, information learned by the NN-B model 520 while performing the NN-B task. Similarly, the efficiency and effectiveness of the information exchange between the NN-A model 510 and the NN-B model 520 are further enhanced because the MDMLX 530 allows the NN-B model 520 to improve its performance of the NN-B task by incorporating, through the MDMLX 530, information learned by the NN-A model 510 while performing the NN-A task. In this manner, the multi-leg NN system 500 in accordance with aspects of the invention is operable to effectively and efficiently perform prediction or classification tasks on the previously-described combined data sets (e.g., the input Type-A and the input Type-B).

The previously-described features and functionality of the multi-leg NN system 500 operate on scenarios where the input Type-A has differences and overlap (or commonalities) with the input Type-B. Additionally, the improved NN-A and NN-B outputs 512, 512A combine to generate an improved single prediction 542.

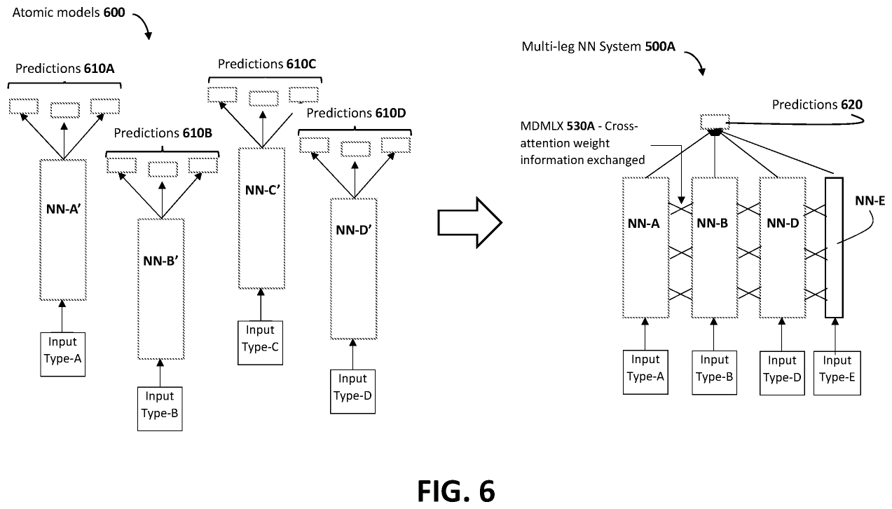

FIG. 6 depicts a non-limiting example of a multi-leg NN system 500A derived from a set of “atomic” models/NNs 600 in accordance with aspects of the invention. The term “atomic” is used herein to define a model/NN that accepts a single data type. Four separate atomic models are shown in FIG. 6 and designated as NN-A′, NN-B′, NN-C′, and NN-D′. NN-A′ performs its task on input Type-A and is substantially the same as the NN-A model 510 shown in FIG. 5, except no MDMLX 530 has been applied. Additionally, the predictions 610A are substantially the same as the NN-A outputs 512. Similarly, NN-B′ performs its task on input Type-B and is substantially the same as the NN-B model 520 shown in FIG. 5, except no MDMLX 530 has been applied. Additionally, the predictions 610B are substantially the same as the NN-B outputs 512A. Similarly, NN-C′ is configured/trained to perform its task on input Type-C and is substantially the same as the NN-A model 510 and/or the NN-B model 520 shown in FIG. 5, except no MDMLX 530 has been applied. Additionally, the predictions 610C are substantially the same as the NN-A and NN-B outputs 512, 512A. Finally, NN-D′ is configured/trained to perform its task on input Type-D and is substantially the same as the NN-A model 510 and/or the NN-B model 520 shown in FIG. 5, except no MDMLX 530 has been applied. Additionally, the predictions 610D are substantially the same as the NN-A and NN-B outputs 512, 512A. Although the atomic models 600 are depicted in FIG. 6 as including four atomic models (NN-A′, NN-B′, NN-C′, NN-D′), any number of atomic models can be provided.

In accordance with aspects of the invention, three of the atomic models in the atomic models 600 are selected for inclusion in a multi-leg NN system 500A shown in FIG. 6 using suitable selection criteria such as the current accuracy performance of each of the atomic models 600 where the top three (3) models are selected. Another suitable approach is selecting a threshold for the selection criteria and selecting atomic models that meet or exceed the threshold. When implemented in the multi-leg NN system 500A, MDMLX 530A is applied to generate NN-A, NN-B, and NN-D, configured and arranged as shown which together work to make predictions 620 which are improved over those predictions 610A, 610B, 610C, 610D shown to the left in FIG. 6. NN-A and NN-B are substantially the same as the NN-A model 510 and the NN-B model 520, respectively. NN-D is also the substantially the same as the NN-A model 510 and the NN-B model 520 except NN-D operates on input Type-D. A fourth model NN-E is added to the multi-leg NN system 500A. NN-E is set up to be trained on input Type-E with assistance from the cross-attention weight information that is shared, using MDMLX 530A, from NN-A, NN-B, and NN-D to NN-E.

In accordance with aspects of the invention, input Type-E is a new data type that is insufficient in quantity and/or content to on its own configure/train NN-E to a predetermined level of model performance (e.g., model prediction/classification performance) that is acceptable or suitable for the model task performed by NN-E, but the predetermined level of model performance can be reached by training NN-E to contribute to the predictions 620 using the cross-attention weight information that is shared, using MDMLX 530A, from NN-A, NN-B, and NN-D to NN-E. In general, the process of building a NN model includes three steps, namely, feeding the NN model with training data, allowing the NN model to learn patterns from the training data, and testing the trained NN model with previously unseen data (e.g., test data). The testing operations can be monitored to gather performance metrics that measure the NN model's level of performance (e.g., prediction/classification performance). There are multiple model performance metric types, including, for example, “precision” performance metrics, “recall” performance metrics, “F-scores,” “Receiver operating characteristic area under curve” (ROC-AUC), and “accuracy” performance metrics. Precision metrics attempt to answer the question of what proportion of positive identifications was actually correct. A precision metric measures the true positives divided by a combination of the true positives with the false positives. A true positive (TP) is an outcome where the NN model correctly predicts the positive class. Similarly, a true negative (TN) is an outcome where the model correctly predicts the negative class. A false positive (FP) is an outcome where the model incorrectly predicts the positive class total. A false negative (FN) is an outcome where the model incorrectly predicts the negative class. For a NN model with TP=1 and FP=2, the precision metric would be 1/(1+1)=0.5. Thus, the NN model has a precision of 0.5, which means that outputs (e.g., predictions/classifications) generated by the NN model are correct 50% of the time.

Recall metrics attempt to answer the question what proportion of actual positives are identified correctly. A recall metric measures TP/(TP+FN). For a NN model with TP=1 and FN=8, the recall metric would be 1/(1+8)=0.5. Thus, the NN model has a precision of 0.5, which means that outputs (e.g., predictions/classifications) generated by the NN model are correct about 11% of the time. ROC-AUC is a curve that maps the relationship between the TP rate and the FP rate of the NN model across different cut-off thresholds. In ROC-AUC, ROC is a probability curve, and AUC represents the degree or measure of separability. In general, the higher the AUC, the better the NN model's performance. The ROC is generated by calculating and outling TPR and FPR at various thresholds. The ROC-AUC score ranges from 0.5 to 1, where 1 is the best score, and 0.5 indicates that the model performs as well as the base model. Accuracy is a metric that measures how often the NN model correctly predicts the outcome, both TP and TN. The accuracy metric can be computed by dividing the number of correct predictions (TP+TN) by the total number of predictions.

In general, the performance metric or metrics used are matched to the type of NN model and the nature of the task; and the predetermined level of model performance (e.g., model prediction/classification performance) that is acceptable or suitable is set based on the model task performed by the NN model (e.g., NN-E). More specifically, in aspects of the invention, the predetermined level of model performance that is acceptable is matched to the relative importance of the prediction/classification task performed by the NN model. For example, where the prediction/classification task is a medical diagnosis, an accuracy metric is selected, and the predetermined level of prediction/classification accuracy can be set relatively high (e.g., at or above about 90% prediction/classification accuracy). As another example, where the prediction/classification task is assisting individuals with performing image searches over the internet, an accuracy metric is selected, and the predetermined level of prediction/classification accuracy can be set relatively at or above about 70% prediction/classification accuracy.

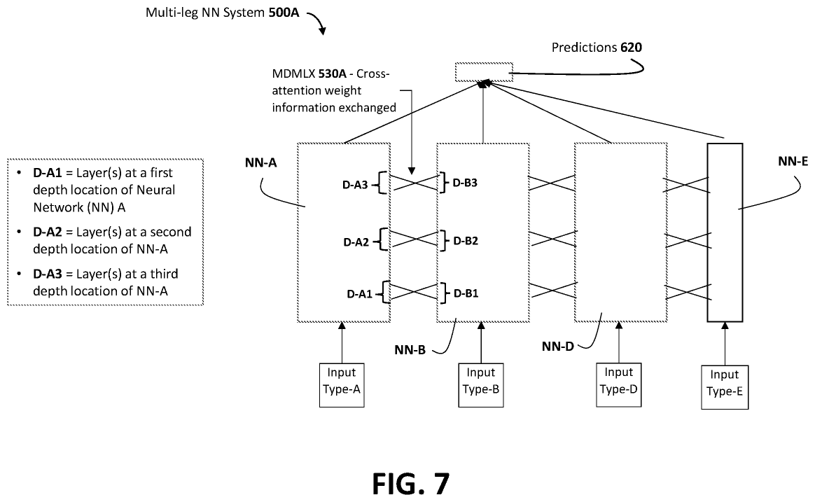

FIG. 7 depicts a non-limiting example of the multi-leg NN system 500A annotated to illustrate the various depths of the NN-A, NN-B, NN-D, and NN-E. As shown, D-A1 represents layer(s) at a first depth location of NN-A; D-A2 represents layer(s) at a second depth location of NN-A; and D-A3 represents layer(s) at a third depth location of NN-A. Similarly, D-B1 represents layer(s) at a first depth location of NN-B; D-B2 represents layer(s) at a second depth location of NN-B; and D-B3 represents layer(s) at a third depth location of NN-B. Substantially the same depth levels apply to NN-D and NN-E. In at least some embodiments, the depth location applies to a sequential order position of a layer within the total layers of a particular leg for receiving information in the feedforward direction. Thus, under this reasoning a layer which first receives the input (compared to other layers of the same leg) is referred to as being at a first depth location. The next layer which receives inputs from the first layer is referred to as being at a second depth location because this layer is the second layer in a sequential order of all layers of the same leg to receive the information passed through. The following layer which receives inputs from the second layer is referred to as being at a third depth location because this layer is the third layer in a sequential order of all layers of the same leg to receive the information passed through.

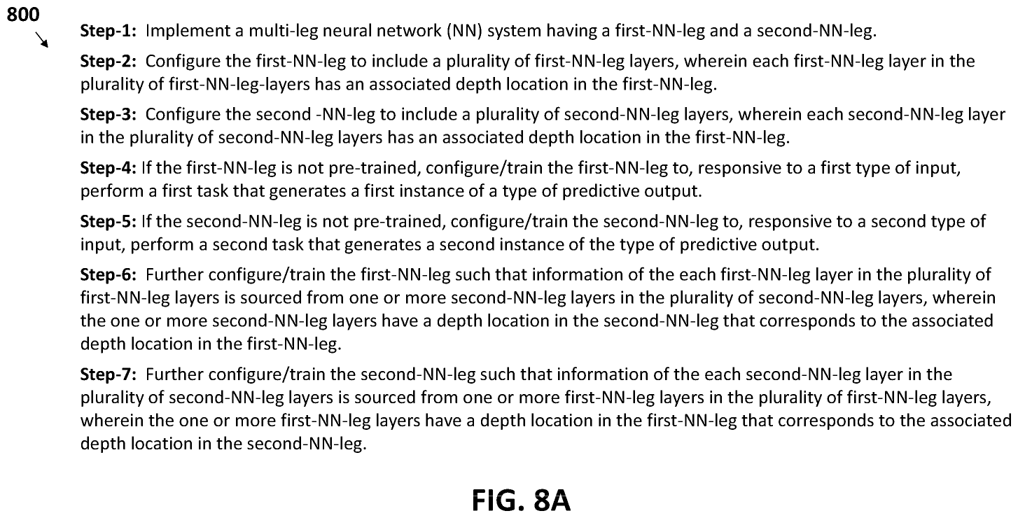

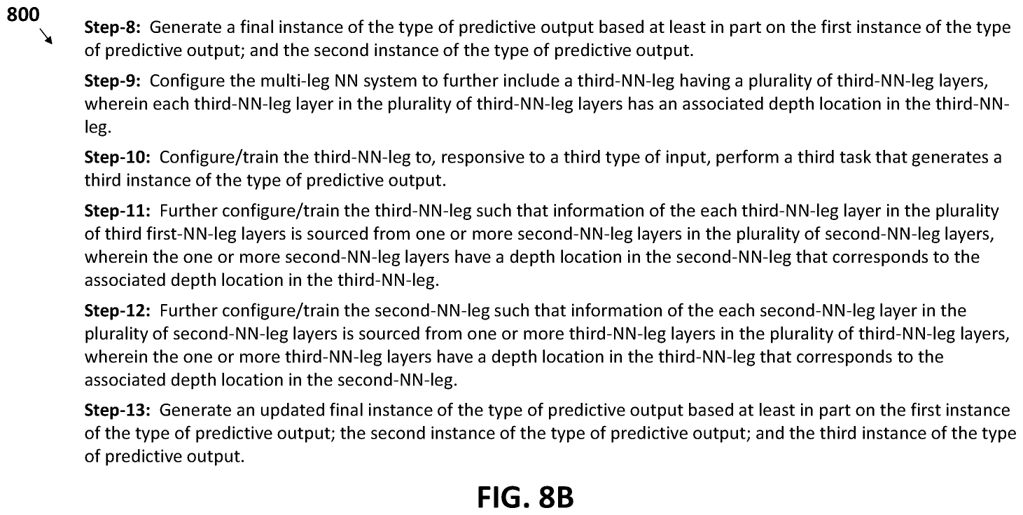

FIG. 8A depicts a first part of a flow diagram illustrating a computer-implemented methodology 800 according to aspects of the invention; and FIG. 8B depicts a second part of the flow diagram depicted in FIG. 8A in accordance with aspects of the invention. As shown in FIG. 8A, the methodology 800 begins at Step-1 and implements a multi-leg neural network (NN) system having a first-NN-leg and a second-NN-leg. In Step-2, the first-NN-leg is configured to include a plurality of first-NN-leg layers, where each first-NN-leg layer in the plurality of first-NN-leg-layers has an associated depth location in the first-NN-leg. In Step-3, the second-NN-leg is configured to include a plurality of second-NN-leg layers, where each second-NN-leg layer in the plurality of second-NN-leg layers has an associated depth location in the first-NN-leg. In Step-4, if the first-NN-leg is not pre-trained, the first-NN-leg is configured/trained to, responsive to a first type of input, perform a first task that generates a first instance of a type of predictive output. In Step-5, if the second-NN-leg is not pre-trained, the second-NN-leg is configured/trained to, responsive to a second type of input, perform a second task that generates a second instance of the type of predictive output. In Step-6, the first-NN-leg is further configured/trained such that information of each first-NN-leg layer in the plurality of first-NN-leg layers is sourced from one or more second-NN-leg layers in the plurality of second-NN-leg layers. The one or more second-NN-leg layers have a depth location in the second-NN-leg that corresponds to the associated depth location in the first-NN-leg. In Step-7, the second-NN-leg is further configured/trained such that information of each second-NN-leg layer in the plurality of second-NN-leg layers is sourced from one or more first-NN-leg layers in the plurality of first-NN-leg layers. The one or more first-NN-leg layers have a depth location in the first-NN-leg that corresponds to the associated depth location in the second-NN-leg.

As shown in FIG. 8B, the methodology 800 continues at Step-8 to generate a final instance of the type of predictive output based at least in part on the first instance of the type of predictive output and on the second instance of the type of predictive output. In Step-9, the multi-leg NN system is configured to further include a third-NN-leg having a plurality of third-NN-leg layers. Each third-NN-leg layer in the plurality of third-NN-leg layers has an associated depth location in the third-NN-leg. In Step-10, the third-NN-leg is configured/trained to, responsive to a third type of input, perform a third task that generates a third instance of the type of predictive output. In Step-11, the third-NN-leg is further configured/trained such that information of each third-NN-leg layer in the plurality of third first-NN-leg layers is sourced from one or more second-NN-leg layers in the plurality of second-NN-leg layers. The one or more second-NN-leg layers have a depth location in the second-NN-leg that corresponds to the associated depth location in the third-NN-leg. In Step-12, the second-NN-leg is further configured/trained such that information of each second-NN-leg layer in the plurality of second-NN-leg layers is sourced from one or more third-NN-leg layers in the plurality of third-NN-leg layers. The one or more third-NN-leg layers have a depth location in the third-NN-leg that corresponds to the associated depth location in the second-NN-leg. In Step-13, an updated final instance of the type of predictive output is generated based at least in part on the first instance of the type of predictive output, on the second instance of the type of predictive output, and on the third instance of the type of predictive output.

In various aspects, such multi-leg neural networks with transfer learning at multiple depths are concretely implementable, in terms of software coding, via explicit constraint or definition of neural network layer input and output paths. That is, for each new cross-attention stitching to be applied between different legs of the multi-leg neural network that is desired, one or more respective lines of software code can be written so as to define the stitching between a target embedding layer and a source embedding layer.

The present embodiments allow the combination of already-trained models via cross-attention layers to improve performance. Using already trained models is a helpful advantage for some embodiments and allows the process to quickly reach acceptable performance from the start. Thus, the process can be achieved with less data needed to fine-tune the combined model. The present embodiments also allow the combination of arbitrary types of inputs, that do or do not have pretrained models. The present embodiments can be implemented in a static architecture which needs training for a much smaller set of parameters. Thus, less training data is required. Using cross-attention layers within the pre-trained networks allows better information propagation between the different inputs, especially in the scenario where the pre-trained networks are further fine-tuned together with the cross-attention weights. During training of the multi-leg neural network model, the pre-trained model weights are frozen in some embodiments while cross-attention parameters are trained. In alternative embodiments, all of the resulting parameters (pre-trained weights and cross-attention parameters (for crossing between multiple legs) are trained together. In at least some embodiments the cross attention layers are placed after the transformer blocks.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method comprising:
executing a multi-leg neural network (NN) comprising a first-NN-leg and a second-NN-leg, wherein:
the first-NN-leg comprises first-NN-leg layers;
a first layer of the first-NN-leg layers is at a first depth location in the first NN-leg that corresponds with a first depth location in the second-NN-leg;
a second layer of the first-NN-leg layers is at a second depth location in the first-NN-leg that corresponds with a second depth location in the second-NN-leg;
information of the first layer of the first-NN-leg layers is sourced from the first depth location in the second-NN-leg; and
information of the second layer of the first-NN-leg layers is sourced from the second depth location in the second-NN-leg.

2. The computer-implemented method of claim 1, wherein the executing comprises:
receiving input comprising a first input type and a second input type to the multi-leg NN; and
in response to receiving the input, generating via the multi-leg NN an output for a machine learning main task.

3. The computer-implemented method of claim 1, wherein:
the second-NN-leg comprises second-NN-leg layers;
a first layer of the second-NN-leg layers is at the first depth location in the second-NN-leg;
a second layer of the second-NN-leg layers is at the second depth location in the second-NN-leg;
information of the first layer of the second-NN-leg layers is sourced from the first depth location in the first-NN-leg; and
information of the second layer of the second-NN-leg layers is sourced from the second depth location in the first-NN-leg.

4. The computer-implemented method of claim 1, wherein the first layer and the second layer are embedding layers, respectively.

5. The computer-implemented method of claim 1, wherein:
the first-NN-leg is operable to, responsive to a first type of input, perform a first task that generates a first instance of a type of predictive output; and
the second-NN-leg is operable to, responsive to a second type of input, perform a second task that generates a second instance of the type of predictive output.

6. The computer-implemented method of claim 5, wherein:
at least a portion of the first type of input is different from at least a portion of the second type of input;
at least a portion of the first task is different from at least a portion of the second task; and
the multi-leg NN generates a final instance of the type of predictive output based at least in part on:
the first instance of the type of predictive output; and
the second instance of the type of predictive output.

7. The computer-implemented method of claim 5, wherein:
the multi-leg NN further comprises a third-NN-leg that, responsive to a third type of input, performs a third task that generates a third instance of the type of predictive output.

8. The computer-implemented method of claim 7, wherein:
information of the third-NN-leg is sourced from the second-NN-leg;
and
the multi-leg NN generates a final instance of the type of predictive output based at least in part on:
the first instance of the type of predictive output;
the second instance of the type of predictive output; and
the third instance of the type of predictive output.

9. The computer-implemented method of claim 8, wherein the third-NN-leg is insufficient to perform the third task without the information that is sourced from the second-NN-leg.

10. A computer system comprising:
a processor system and a memory electronically coupled to the processor system, wherein the memory stores a multi-leg neural network (NN) comprising a first-NN-leg and a second-NN-leg, wherein:
the first-NN-leg comprises first-NN-leg layers;
a first layer of the first-NN-leg layers is at a first depth location in the first NN-leg that corresponds with a first depth location in the second-NN-leg;
a second layer of the first-NN-leg layers is at a second depth location in the first-NN-leg that corresponds with a second depth location in the second-NN-leg;
information of the first layer of the first-NN-leg layers is sourced from the first depth location in the second-NN-leg; and
information of the second layer of the first-NN-leg layers is sourced from the second depth location in the second-NN-leg.

11. The computer system of claim 10, wherein the multi-leg NN is configured to generate an output for a machine learning task in response to receiving an input comprising a first input type and a second input type.

12. The computer system of claim 10, wherein:
the second-NN-leg comprises second-NN-leg layers;
a first layer of the second-NN-leg layers is at the first depth location in the second-NN-leg;
a second layer of the second-NN-leg layers is at the second depth location in the second-NN-leg;
information of the first layer of the second-NN-leg layers is sourced from the first depth location in the first-NN-leg; and
information of the second layer of the second-NN-leg layers is sourced from the second depth location in the first-NN-leg.

13. The computer system of claim 10, wherein the first layer and the second layer are embedding layers, respectively.

14. The computer system of claim 10, wherein:
the first-NN-leg is operable to, responsive to a first type of input, perform a first task that generates a first instance of a type of predictive output; and
the second-NN-leg is operable to, responsive to a second type of input, perform a second task that generates a second instance of the type of predictive output.

15. The computer system of claim 14, wherein:
at least a portion of the first type of input is different from at least a portion of the second type of input;
at least a portion of the first task is different from at least a portion of the second task; and
the multi-leg NN is operable to generate a final instance of the type of predictive output based at least in part on:
the first instance of the type of predictive output; and
the second instance of the type of predictive output.

16. The computer system of claim 14, wherein:
the multi-leg NN further comprises a third-NN-leg that, responsive to a third type of input, performs a third task that generates a third instance of the type of predictive output.

17. The computer system of claim 16, wherein:
information of the third-NN-leg is sourced from the second-NN-leg;
and
the multi-leg NN is operable to generate a final instance of the type of predictive output based at least in part on:
the first instance of the type of predictive output;
the second instance of the type of predictive output; and
the third instance of the type of predictive output.

18. The computer system of claim 17, wherein the third-NN-leg is insufficient to perform the third task without the information that is sourced from the second-NN-leg.

19. A computer program product comprising a computer readable storage medium storing a multi-leg neural network (NN) comprising a first-NN-leg and a second-NN-leg, wherein:
the first-NN-leg comprises first-NN-leg layers;
a first layer of the first-NN-leg layers is at a first depth location in the first NN-leg that corresponds with a first depth location in the second-NN-leg;
a second layer of the first-NN-leg layers is at a second depth location in the first-NN-leg that corresponds with a second depth location in the second-NN-leg;
information of the first layer of the first-NN-leg layers is sourced from the first depth location in the second-NN-leg; and
information of the second layer of the first-NN-leg layers is sourced from the second depth location in the second-NN-leg.

20. The computer program product of claim 19, wherein the multi-leg NN is configured to generate an output for a machine learning task in response to receiving an input comprising a first input type and a second input type.
